(19) United States
(12) Patent Application Publication
(10) Pub. No.: US 2017/0349472 A1
(43) Pub. Date: Dec. 7, 2017

(54) DEVICE FOR MOLDING GLASS CURVED SURFACE AND METHOD FOR MOLDING GLASS CURVED SURFACE BY USING SAME

(71) Applicant: SAMSUNG ELECTRONICS CO., LTD., Suwon-si, Gyeonggi-do (KR)

(72) Inventors: Sang-jun JUNG, Hwaseong-si, Gyeonggi-do (KR); Dong-oh MIN, Suwon-si, Gyeonggi-do (KR); Jeong-soo YEA, Gwangsan-gu, Gwangju (KR); Jong-duck LEE, Seongnam-si, Gyeonggi-do (KR); Sung-jin JANG, Yongin-si, Gyeonggi-do (KR); Kyung-sun CHOI, Suwon-si, Gyeonggi-do (US)

(21) Appl. No.: 15/537,079

(22) PCT Filed: Jun. 26, 2015
(86) PCT No.: PCT/KR2015/006553

§ 371 Date: Jun. 16, 2017

(30) Foreign Application Priority Data
Dec. 19, 2014 (KR) 10-2014-0184290
Jun. 5, 2015 (KR) 10-2015-0079682

(51) Int. Cl. C03B 23/03; C03B 23/035; C03B 11/16; C03B 35/20

(52) U.S. Cl. CPC C03B 23/0307; C03B 23/0357; C03B 23/0302; C03B 11/16; C03B 35/207

(57) ABSTRACT

A apparatus for molding curved glass comprises: a plurality of mold units formed in a chamber for thermomolding and including a lower mold which has one or more cavities such that each of the cavities is injected with glass and an upper mold corresponding to the shape of glass to be processed and arranged on the upper side of the lower mold; and first and second processing apparatuses respectively including an inlet part for the plurality of mold units which are put, a preheating part for increasing the temperature of the glass, a molding part for molding the glass, a cooling part for cooling the molded glass and an outlet part for discharging the cooled glass, wherein the molding part can gradually decrease the increase rate of the heat applied to the plurality of mold units from the inlet part side to the cooling part side.

### TECHNICAL FIELD

Apparatuses and methods consistent with the present invention relate to an apparatus for molding curved glass and a method for molding curved glass using the same, and more particularly, an apparatus for molding curved glass and a method for molding curved glass using the same, for putting a plurality of mold units in which a flat glass is positioned into a heated chamber and then forming the glass with a curved surface via vacuum adsorption or compression.

### BACKGROUND ART

An electronic device such as a mobile phone and a digital camera uses a liquid crystal display device or an organic light emitting diode (OLED) display device so as to allow a user to display a display unit. A transparent window glass is disposed in front of the display device.

Recently, as portable devices with a curved surface have been developed, there has increasingly been a need for a widow including a curved surface. In general, differently from plate glass products, curved glass products applied to various electronic products are manufactured by molding a plate glass, which is cut according to the standard of a curved shape of the product, via thermal deformation using a mold.

Conventionally, molding is performed only via press pressure in order to manufacture a curved glass and, thus, quality deviation occurs. In order to overcome this issue, a technology of manufacturing a curved glass using vacuum adsorption and heat has been developed but heat applied to a mold is not capable of being effectively controlled to cause product errors.

According to the conventional technology, a mold unit with a single cavity is permitted to pass between an upper heater unit and a lower heater unit and, thus, the productivity of curved glasses is not high. In addition, when a plurality of mold units are arranged in parallel, there is a problem in that the molding quality of a glass is not uniform due to a temperature difference between an end portion and a center portion of each heater unit.

### DISCLOSURE

The present invention provides an apparatus for molding curved glass and a method for molding curved glass using the same, for manufacturing curved glass with high quality by controlling adsorptive power and heat step by step via adsorption and compression and for configuring a multi-cavity mold unit so as to reduce molding quality deviation for each cavity.

The present invention provides an apparatus for molding curved glass and a method for molding curved glass using the same, for minimizing an installation area and reducing installation costs by configuring mold physical distribution as a 2 column rotation structure.

According to an aspect of the present invention, an apparatus for molding curved glass includes a plurality of mold units formed as one or more cavities in a chamber for thermal molding and including a lower mold in which glass is put into each cavity and an upper mold corresponding to a shape of a glass to be processed and disposed on the lower mold, and first and second processing apparatuses each including an inlet part into which the plurality of mold units are put, a preheating part configured to heat the glass, a molding part configured to mold the glass, a cooling part configured to cool the glass molded in the molding part, and an outlet part from which the glass cooled by the cooling part is discharged, wherein the molding part gradually reduces a rate of increase of heat applied to the plurality of mold units toward the cooling part from the inlet part.

The molding part may include first fixing unit spaced apart below the plurality of mold units, and second fixing unit spaced apart above the plurality of mold units.

The first and second fixing units may each include a plurality of temperature control blocks, and the temperature control block may include at least one heating block configured to heat the plurality of mold units, at least one heat sink stacked on the heating block to contact the heating block, and at least one cooling block stacked on a plate and formed to lower temperature of the first and second fixing units.

A contact area of the plurality of heat sink with the heating block may be gradually increased toward the cooling part from the inlet part.

As the contact area of the plurality of heat sinks with the heating block is gradually increased,

The cooling block and the heating block may exchange heat and a rate of increase of temperature of the plurality of mold units in the chamber is gradually reduced toward the cooling part from the inlet part.

Each of the heat sinks may have a hollow portion with at least one polygon.

A straight line type protrusion may be periodically and repeatedly formed on upper portion and lower portion of each heat sink.

A suction passage connected to a vacuum suction device may be formed in the first fixing unit and the suction passage extends to a suction hole formed on an upper portion of the heating block of the first fixing unit.

The lower mold may include a suction flow path formed on a lower portion of the lower mold, and the plurality of mold units may perform vacuum adsorption on a lower portion of the glass for a predetermined time at a location corresponding to the suction flow path and the suction hole and, simultaneously, may compress an upper portion of the glass by self load of the upper mold and an upper heat unit.

The plurality of mold units may be molded in one heating block disposed in the molding part and then moved to the cooling part.

The plurality of mold units may be molded according to suction force that is differently controlled by a plurality of temperature control blocks disposed in the molding part.

The first and second processing apparatuses may be arranged in parallel.

Inert gas may be injected into the chamber to prevent the mold unit from being oxidized.

Opening and closing doors may be formed at opposite ends of the molding part in order to prevent the inert gas from leaking when the plurality of mold units are input or discharged.

Each of the temperature control blocks may further include at least one plate disposed between the heat sink and the cooling block.

The first and second processing apparatuses may be arranged to form a closed loop and constitute a 2 column rotation structure.

According to another aspect of the present invention, a method for molding curved glass includes putting glass into a plurality of mold units, preheating the glass, molding the heated glass, cooling the molded glass, and sequentially extracting the completely cooled glass from each of the mold units, wherein a rate of increase of heat applied to the plurality of mold units is adjusted by each stage.

The molding may include molding the glass via vacuum adsorption of a lower mold of the mold units, self load compression of an upper mold of the mold unit, and an upper heater unit.

According to another aspect of the present invention, an apparatus for molding curved glass including a plurality of mold units including lower molds including a plurality of molding rooms into which a glass is input and upper molds formed above the lower molds with pressure due to self load being applied to the glass as a thermal molding target; and a processing apparatus configured to sequentially move the plurality of mold units to be injected, preheated, cooled, and discharged and to adjust a rate of increase of heat applied to the plurality of mold units to the cooling from the preheating, wherein the lower molds are integrally formed and the upper molds are separately formed to correspond to respective molding rooms of the lower molds, and the upper molds may be spaced apart from each other by a preset interval. In this case, the processing apparatus may gradually reduce a rate of increase of heat toward the cooling from the preheating.

The processing apparatus may include lower heater units disposed below the plurality of mold units and upper heater units spaced apart above the plurality of mold units for thermal molding.

The upper heater units may be separately formed above the upper molds, respectively.

### DESCRIPTION OF DRAWINGS

FIG. 1 is a schematic plan view of an apparatus for molding curved glass according to an exemplary embodiment of the present invention.

FIG. 2 is a perspective view of a mold unit illustrated in FIG. 1.

FIG. 3A is a cross-sectional view of a molding part illustrated in FIG. 1.

FIG. 3B is an exploded perspective view of a first temperature control block illustrated in FIG. 3A.

FIG. 4 is a plan view in which a shape of a heat sink is varied according to an exemplary embodiment of the present invention.

FIG. 5 is a cross-sectional view of a mold unit that enters a molding part according to an exemplary embodiment of the present invention.

FIG. 6 is a cross-sectional view of a mold unit in which glass molding is completed according to an exemplary embodiment of the present invention.

FIG. 7 is a cross-sectional view of a first modified example of a mold unit and an upper heater unit according to an exemplary embodiment of the present invention.

FIG. 8 is a cross-sectional view of a first modified example of a mold unit that enters a molding operation according to an exemplary embodiment of the present invention.

FIG. 9 is a cross-sectional view of a first modified example of a mold unit in which glass molding is completed according to an exemplary embodiment of the present invention.

FIG. 10 is a diagram illustrating a change in temperature of a mold unit during passing through a first processing apparatus according to an exemplary embodiment of the present invention.

FIG. 11 is a block diagram for explanation of a method for molding curved glass according to an exemplary embodiment of the present invention.

### MODE FOR INVENTION

Hereinafter, an apparatus for molding curved glass will be described with regard to exemplary embodiments of the invention with reference to the attached drawings. However, the present invention may be implemented in various different forms and is not limited to these embodiments.

Hereinafter, an apparatus for molding curved glass 1000 according to an exemplary embodiment of the present invention will be described.

The apparatus for molding curved glass 1000 may include a first processing apparatus 100 and a second processing apparatus 100a. The first processing apparatus 100 and the second processing apparatus 100a may be arranged to face each other. A plurality of mold units 150 may be moved along a closed loop including the first and second processing apparatuses 100 and 100a. The first processing apparatus 100 and the second processing apparatus 100a may be arranged in parallel.

The first processing apparatus 100 may include an inlet part I₁, a molding part 130, a mold standby part 101, a cooling part 140, a mold unit 150, moving parts 160 and 170, an actuator 180, and an outlet part O₁.

The inlet part I₁ may be used to put the mold unit 150 into the first processing apparatus 100 after putting a plate type glass G on the mold unit 150 by an operator. The mold unit 150 may be moved to a first moving part 160 by a first actuator 181.

The molding part 130 may be used to the mold unit 150 via heat and vacuum adsorptive power of first and second fixing units F1 and F2. The molding part 130 may include a preheating part 110 and a curved surface molding part 120. The plurality of mold units 150 that are spaced apart from each other between the first and second fixing units F1 and F2 may be moved into the molding part 130 by the first moving part 160. The molding part 130 may be surrounded by a chamber 400 and isolated from atmosphere in the chamber 400 so as to prevent heat from being dissipated out of the chamber 400.

The preheating part 110 may apply heat to the mold unit 150 in room temperature to increase temperature of the mold unit 150 to predetermined temperature. The preheating part 110 may include a first preheating part 111 and a second preheating part 113. In the present invention, for convenience of description, the two preheating parts 111 and 113 are exemplified. However, one preheating part 110 or three or more preheating parts 110 may be used, needless to say.

When the mold unit 150 is moved into the chamber 400 by the first moving part 160, the first preheating part 111 may pre-heat the mold unit 150 for predetermined time. When the mold unit 150 is moved to the second preheating part 113 by the first moving part 160, temperature of the mold unit 150 rises due to additional heat. For example, the mold unit 150 may be heated to 300° C. in the first preheating part 111 and heated to 400° C. in the second preheating part 113.

The curved surface molding part 120 may be used to form the glass G to a desired curved surface by simultaneously performing heating, vacuum adsorption, and compression via self load. The curved surface molding part 120 may include first to seventh curved surface molding parts 121, 122, 123, 124, 125, 126, and 127. According to the present invention, for convenience of description, the curved surface molding part 120 is exemplified as seven curved surface molding parts including the first curved surface molding part 121 to the seventh curved surface molding part 127. However, needless to say, the glass G is formed in one curved surface molding part 120.

The mold unit 150 may be moved by the first moving part 160 via sliding over the first fixing unit F1 formed on each of the curved surface molding parts 121, 122, 123, 124, 125, 126, and 127. Then, one end 152 of an suction flow path 159 of the mold unit 150 may be positioned to correspond to a suction hole 211 of the first fixing unit F1.

For example, vacuum adsorptive power is applied to a lower portion of the glass G for 140 seconds. In addition, heat from heating blocks 210 and 310 of first and second temperature control blocks 200 and 300 is applied to upper and lower portions of the glass G for the above time period. In addition, compressive force due to self load of an upper mold 151 is applied to the upper portion of the glass G for the above time period. As the mold unit 150 is moved step by step along each of the curved surface molding parts 121, 122, 123, 124, 125, 126, and 127, adsorptive power and heat may be controlled stepwise according to different adsorptive power and different heat. Accordingly, thermal distortion of the glass G may be prevented and, thus, quality deviation of the curved surface glass G may not occur. In addition, crack may not occur in the glass G and, thus, the curved surface glass G with high quality may be produced.

The mold standby part 101 is a portion in which the mold unit 150 discharged from the curved surface molding part 120 is on standby. Shielding doors 453 and 455 for preventing heat or inert gas in the chamber 400 from being externally discharged may be installed before and after the mold standby part 101. The mold unit 150 in the mold standby part 101 may be moved into the cooling part 140 by the first moving part 160.

The cooling part 140 is a portion in which the curved surface glass G moved into the cooling part 140 is cooled by cooling air to lastly form the curved surface glass G. The glass G moved into the cooling part 140 may be cooled to temperature similar to room temperature. The plurality of cooled mold units 150 may be moved to the outlet part O₁ by a second actuator 183. In the cooling part 140, the plurality of mold units 150 may be moved by the second moving part 170.

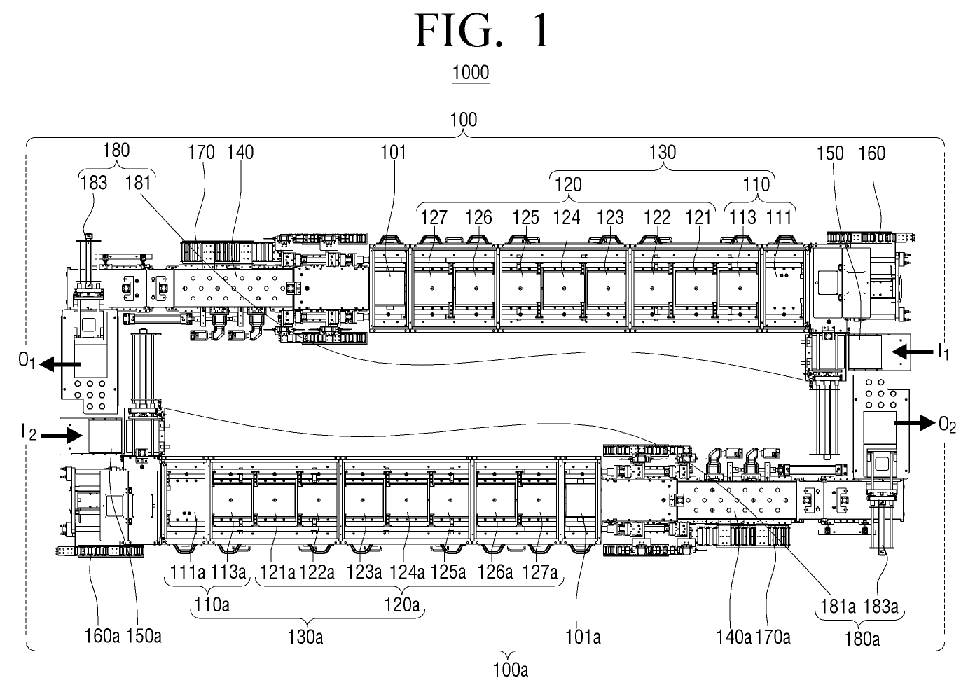

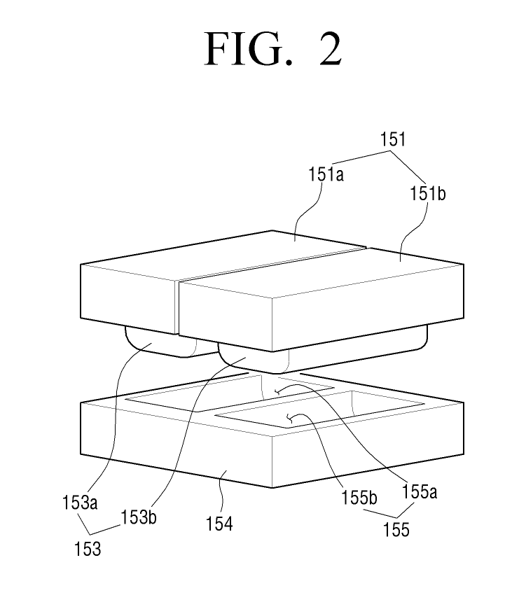

With reference to FIGS. 1 and 2, the mold unit 150 will be described in detail. For convenience of description, FIG. 1 illustrates an example in which one mold unit 150 is put into the inlet part I₁. However, a plurality of mold units 150 may be arranged in the first processing apparatus 100 at a predetermined interval.

Referring to FIG. 2, the mold unit 150 may include upper molds 151 and 153 and lower molds 154 and 155 that are formed of a metallic material. The mold unit 150 is used for thermal molding. The glass G may be put into the mold unit 150 to form a desired curved surface by simultaneously performing vacuum adsorption, heating, and compression.

The upper molds 151 and 153 may include a mold cover 151 and a curved surface mold frame 153. The mold cover 151 may be formed to a predetermined thickness in order to apply compressive force via self load to the glass G. The curved surface mold frame 153 may include two curved portions with predetermined curvature corresponding to a curved surface of the completely molded glass G and one flat portion for providing a flat surface to the glass G.

According to the present invention, the mold unit 150 as a multi-cavity mold includes two mold covers 151a and 151b, two curved surface molding frames 153a and 153b, and two molding rooms 155a and 155b. However, needless to say, the mold unit 150 may include three or more multi-cavities formed therein.

The lower molds 154 and 155 may include a molding room case 154 and a molding room 155.

The molding room case 154 forms an outer appearance of the lower molds 154 and 155. The moving part 160 pushes the molding room case 154 of each mold unit 150 at once so as to move the plurality of mold units 150 in the molding part 130.

A plurality of molding rooms 155 may be arranged in the molding room case 154 and the glass G as a molding target may be positioned in each of the molding rooms 155a and 155b. Each of the molding rooms 155a and 155b may include two curved portions with predetermined curvature corresponding to a shape of each of the molding frames 153a and 153b and one flat portion for providing a flat surface to the glass G. That is, the molding rooms 155a and 155b may each have an upper surface with the same shape as the glass G as a molding target and may have engaged shapes.

In operation in which the glass G reaches a softening point and a curved surface is formed with a predetermined curvature to complete molding, the molding frames 153a and 153b may be accommodated in the molding rooms 155a and 155b, respectively. To this end, widths of the molding frames 153a and 153b may be smaller than widths of the molding rooms 155a and 155b by as much as twice the thickness of the glass G.

The moving parts 160 and 170 may move the plurality of mold units 150 in the first processing apparatus 100. The moving parts 160 and 170 may include the first moving part 160 and the second moving part 170.

The first moving part 160 may move the plurality of mold units 150 in the molding part 130. The first moving part 160 may move the plurality of mold units 150 at once according to forward or backward movement of a one-axis robot (not shown) and normal or reverse rotation of a rotator cylinder (not shown). According to the present invention, the case in which the plurality of mold units 150 are moved by a one-axis robot (not shown) and a rotator cylinder (not shown) is exemplified. However, needless to say, the plurality of mold units 150 may be moved by a chain conveyer.

The second moving part 170 may move the plurality of mold units 150 in the cooling part 140. The second moving part 170 may move the plurality of mold units 150 up to the second actuator 183 step by step.

The actuator 180 may straightly move the mold unit 150. The actuator 180 may include the first actuator 181 for pushing the mold unit 150 put into the inlet part I₁ to the molding part 130 and the second actuator 183 for pushing the mold unit 150 to the outlet part O₁ from an end portion of the cooling part 140.

The second processing apparatus 100a may have the same components as those of the first processing apparatus 100 and the same component is denoted by corresponding reference numerals. Accordingly, a detailed description of the same component will be omitted here.

The second processing apparatus 100a may be disposed to face the first processing apparatus 100. The plurality of mold units 150 may circulate along a closed loop including the first and second processing apparatuses 100 and 100a. According to the present invention, the case in which the first processing apparatus 100 and the second processing apparatus 100a are arranged in parallel is exemplified. However, needless to say, the closed loop including the first and second processing apparatuses 100 and 100a is formed in an oval form.

The apparatus for molding curved glass 1000 according to the present invention is configured to form a closed loop including the first processing apparatus 100 and the second processing apparatus 100a that is the same as the first processing apparatus 100, in which injection, pre-heating, molding, and discharging are performed (refer to FIG. 1). Accordingly, according to the present invention, mold physical distribution may be minimized to minimize an installation area compared with a prior art containing connected physical distribution.

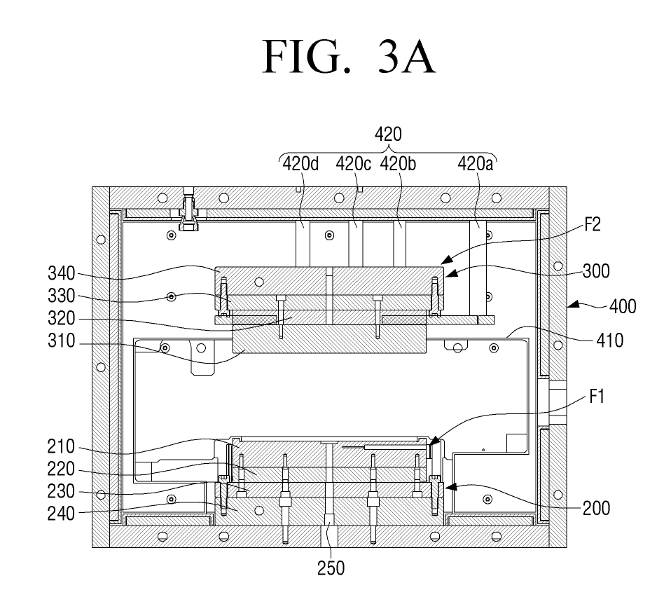

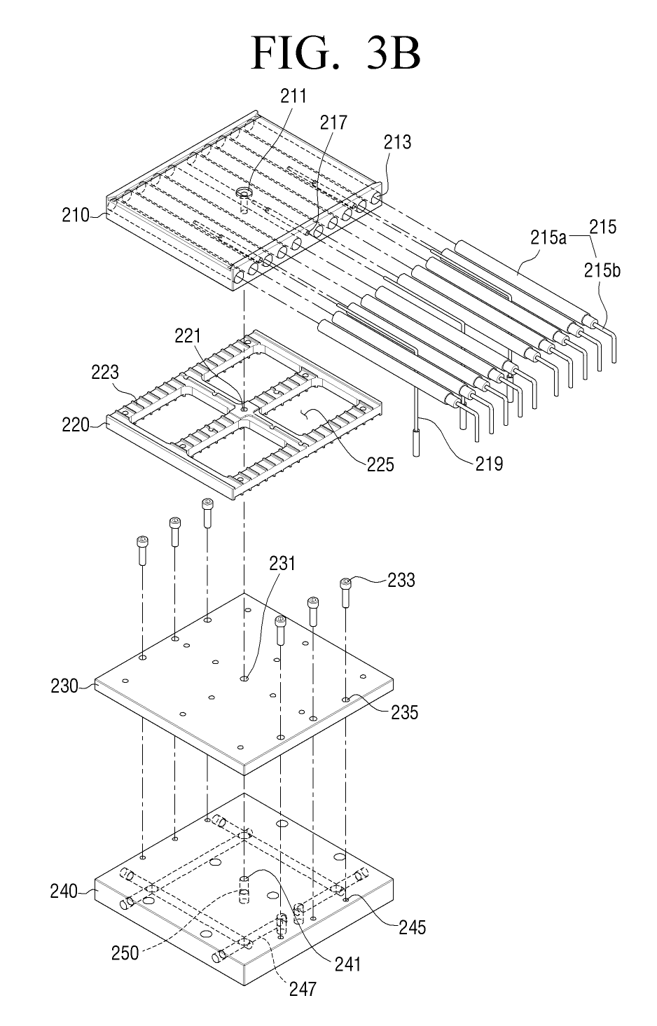

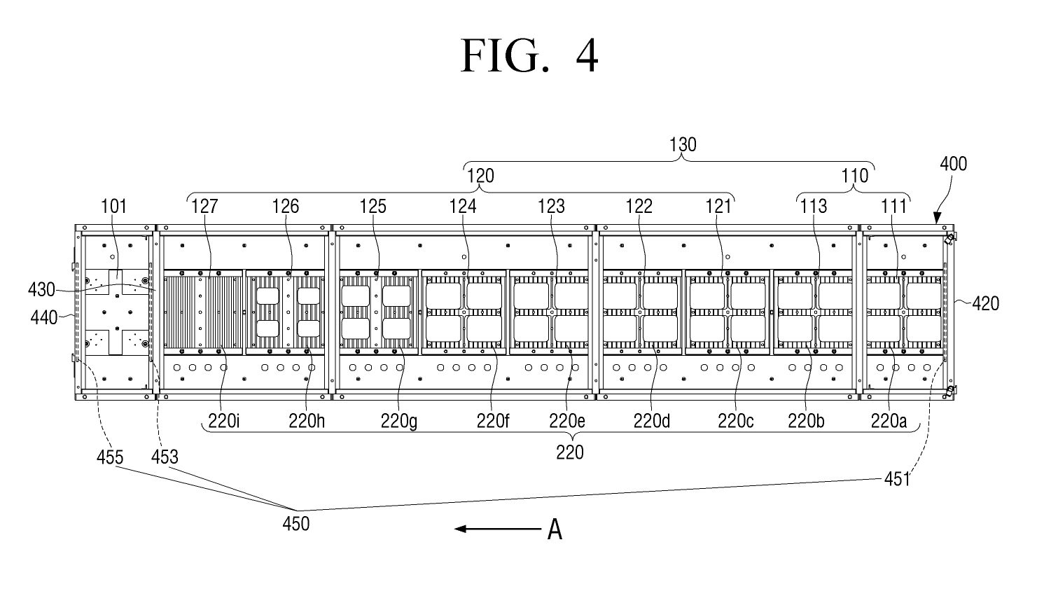

With reference to FIGS. 3A, 3B, and 4, the first and second fixing units F1 and F2 and the chamber 400 will be described in detail.

The first fixing unit F1 and the second fixing unit F2 may be arranged to the seventh curved surface molding part 127 from the first preheating part 111 and may each include the plurality of temperature control blocks 200 and 300. The plurality of mold units 150 may be spaced apart from each other at a predetermined interval and may be moved between the first fixing unit F1 and the second fixing unit F2. The mold unit 150 may be used to perform a molding operation of the glass G while staying on the heating block 210 for a predetermined time period.

The pair of temperature control blocks 200 and 300 may be formed on each of the first and second preheating parts 111 and 123 and each of the curved surface molding parts 121, 122, 123, 124, 125, 126, and 127. Accordingly, the mold unit 150 may be heated with increased temperature while passing through each of the temperature control blocks 200 and 300.

The first temperature control block 200 may include the heating block 210, heat sinks 220, a plate 230, a cooling block 240, and a suction passage 250. The first temperature control block 200 is rectangular parallelepiped overall.

Referring to FIG. 3B, the heating block 210 may heat the plurality of mold units 150. The heating block 210 may include the heating block suction hole 211, a heater accommodation part 213, a heater 215, a thermal couple accommodation part 217, and a thermal couple 219.

The heating block suction hole 211 may be formed in an upper portion of the heating block 210. The heating block suction hole 211 may constitute an end portion of the suction passage 250 connected to a vacuum suction device (not shown) and may be formed to correspond to a inlet hole 152 of the lower mold 154.

The heater accommodation part 213 may accommodate the heater 215 therein. A plurality of heater accommodation parts 213 may be formed through the heating block 210 at a lateral surface of the heating block 210.

The heater 215 may include a heater 215a and a heater cable 215b surrounded by the heater 215a and supply heat to the heating block 210.

The thermal couple accommodation part 217 may accommodate a thermal couple 219. A plurality of thermal couple accommodation parts 217 may be formed through the heating block 210 at a lateral surface of the heating block 210.

The thermal couple 219 may detect temperature at a measurement point and may be inserted into the thermal couple accommodation part 217.

The heat sinks 220 may be stacked between the heating block 210 and the cooling block 240 in order to control temperature of the first temperature control block 200. The heat sinks 220 may each include a heat sink suction hole 221, protrusions 223, and hollow portions 225.

The heat sinks 220 may be arranged below the heating blocks 210 according to one-to-one correspondence. As illustrated in FIG. 4, the heat sinks 220 may include nine heat sinks 220a to 220i from the first preheating part 111 that is one end of the molding part 130 to the seventh curved surface molding part 127 that is the other end of the molding part 130. According to the present invention, heat sinks denoted by 220a to 220f may be formed with the hollow portions 225 with the same size. The remaining heat sinks 220g, 220h, and 220i may be configured with the hollow portions 225 with different sizes. However, for example, needless to say, all of the heat sinks 220a to 220i may be formed with the hollow portions 225 with different sizes.

A contact area of the heat sink 220 with the heating block 210 and the plate 230 is gradually increased as the heat sink 220 approaches the seventh curved surface molding part 127. According to this configuration, more heat of the heating block 210 may be lost by the cooling block 240 toward the seventh curved surface molding part 127. Accordingly, temperature of the mold unit 150 in the curved surface molding part 120 may be controlled to an optimal condition for molding the glass G.

The heat sink suction hole 221 may be disposed at a vertical lower portion of the heating block suction hole 211. The heat sink suction hole 221 may form a portion of the suction passage 250 connected to a vacuum suction device (not shown).

The protrusions 223 may be formed on upper portion and lower portion of the heat sink 220 to contact the heating block 210 and the plate 230. The protrusions 223 may be configured in periodically repeated straight forms.

The hollow portions 225 may be configured to control a contact area of the heat sink 220 with the heating block 210 and the plate 230. According to the present invention, although four hollow portions 225 are used, the hollow portions 225 may be polygonal. The heat sink 220 may include one hollow portion or include the plurality of hollow portions 225.

According to shapes of the protrusions 223 and shapes of the hollow portions 225, a contact area of the heat sink 220 with the heating block 210 and the plate 230 may be determined.

The plate 230 may be stacked between the heat sink 220 and the cooling block 240. The plate 230 may transfer chilly air of the cooling block 240 to the heat sink 220. The plate 230 may be coupled to and fix the first fixing unit F1. To this end, the plate 230 may be configured with a plurality of coupling holes 235 and screws 233. A plate suction hole 231 may be disposed at a vertical lower portion of the heat sink suction hole 221 and may form a portion of the suction passage 250 connected to a vacuum suction device (not shown).

The cooling block 240 may be a cooling device for adjusting temperature of the first temperature control block 200. The cooling block 240 may be staked on the plate 230. The cooling block 240 may include a cooling block suction hole 241, a plurality of coupling holes 245, and a flow path 247.

The cooling block suction hole 241 may be disposed at a vertical lower portion of the plate suction hole 231 and may form a portion of the suction passage 250 connected to a vacuum suction device (not shown).

The plurality of coupling holes 245 may be coupled to the screws 233 of the plate 230.

The flow path 247 is a portion through which cold water passes. The cooling block 240 may lower temperature of the mold unit 150 according to cold water passing through the flow path 247.

The suction passage 250 is a path for connecting the heating block suction hole 211, the heat sink suction hole 221, the plate suction hole 231, and the cooling block suction hole 241. The suction passage 250 may be connected to a vacuum suction device (not shown) to add vacuum adsorptive power to the plurality of mold units 150.

The plurality of second temperature control blocks 300 of the second fixing unit F2 may have almost the same components as the plurality of first temperature control blocks 200 of the first fixing unit F1. However, the second fixing unit F2 does not disclose the same component such as the suction passage 250 of the first fixing unit F1. Accordingly, for convenience of description, the same component as the first fixing unit F1 will be omitted.

The second temperature control block 300 may include a heating block 310, a heat sink 320, a plate 330, and a cooling block 340. Based on the mold unit 150, components of the second temperature control block 300 of the second fixing unit F2 may be stacked to correspond to respective components of the first temperature control block 200 of the first fixing unit F1.

Referring to FIGS. 3A and 4, the chamber 400 may be disposed to surround the plurality of mold units 150 and the first and second fixing units F1 and F2 of the molding part 130.

Inert gas may be supplied into the chamber 400 to prevent the first and second fixing units F1 and F2 and the mold unit 150 from being oxidized. Although not illustrated, inert gas may be discharged by an exhaust pipe.

When the mold unit 150 is put into or out of the chamber 400, a plurality of barriers 420, 430, and 440 may be formed at opposite ends of the molding part 130 and an inlet part of the mold standby part 101 in order to prevent inert gas and heat from leaking. Opening and closing doors 450 may be formed at each barrier. Each of opening and closing doors 451, 453, and 455 may be formed up and down direction so as to be opened for a predetermined time period only during movement of the mold unit 150.

The plurality of mold units 150 may be moved into the chamber 400. In addition, a core chamber 410 in which heating and molding are performed may be located in the chamber 400. The core chamber 410 may be configured with a frame.

In order to support the second fixing unit F2 in the chamber 400, an upper portion of the chamber 400 and the second fixing unit F2 may be supported by a plurality of support brackets 420.

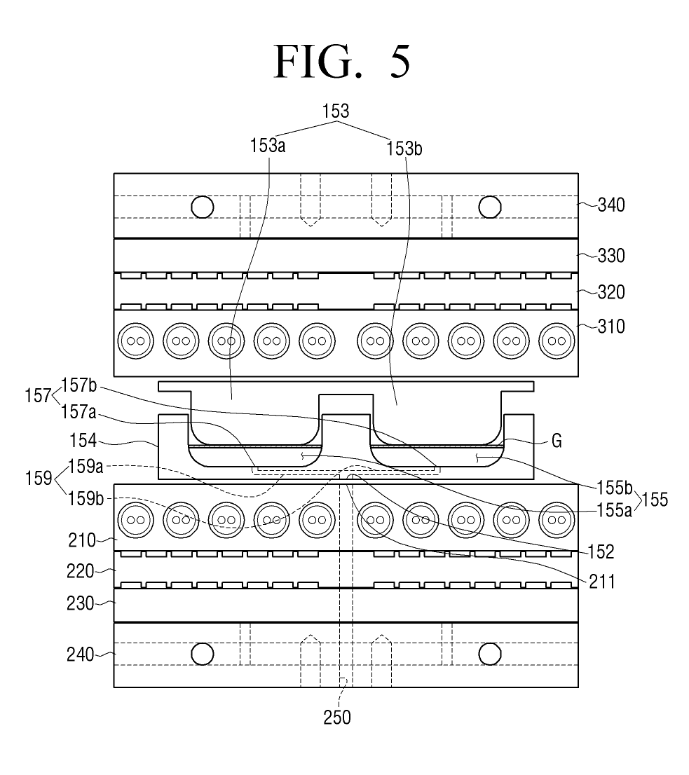

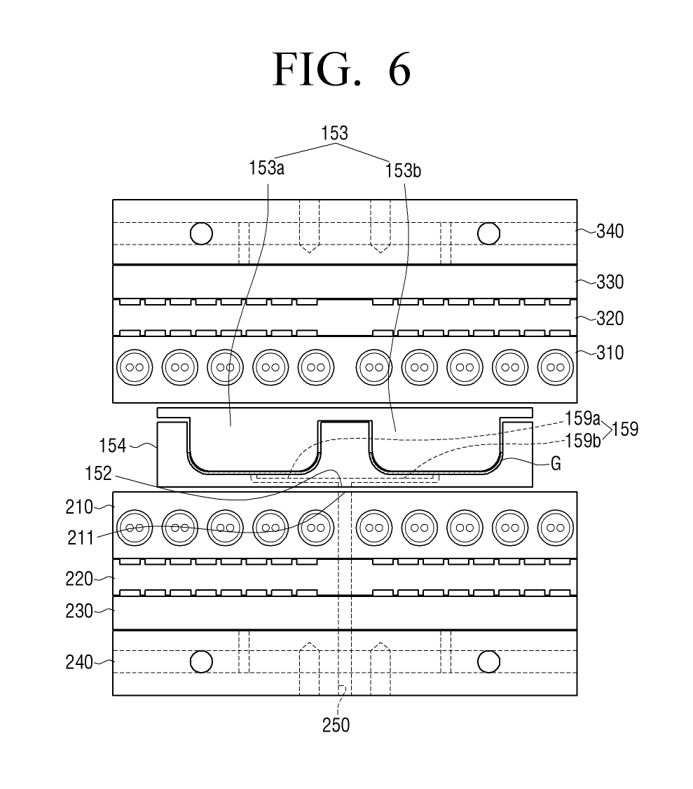

With reference to FIGS. 5 and 6, a molding procedure in the plurality of mold units 150 will be described.

FIG. 5 illustrates a procedure of heating the mold unit 150 in the preheating part 110 or a portion of the curved surface molding part 120 prior to molding. The glass G may be put in each of the molding rooms 155a and 155b of the plurality of mold units 150 disposed between the first and second fixing units F1 and F2. The upper molds 151 and 153 may be put on the glass G. The upper molds 151 and 153 may be integrally formed.

In the preheating part 110, vacuum suction through the suction passage 250 may not be applied to the mold unit 150. However, suction force of a vacuum suction device (not shown) through the suction passage 250 may be applied to a lower portion of the mold unit 150 while entering the curved surface molding part 120. Suction forces at the curved surface molding parts 121, 122, 123, 124, 125, 126, and 127 may be differently controlled.

The first inlet hole 152 corresponding to the suction hole 211 at an upper portion of the heating block 210 may be formed in a lower portion of the molding room case 154. Suction flow paths 159a and 159b connected to second and third inlet holes 157a and 157b at lower portions of the molding rooms 155a and 155b from the inlet hole 152 may be formed. Accordingly, suction force at a vacuum suction device (not shown) may be transferred to the suction passage 250, the suction flow path 159, and the second and third inlet holes 157a and 157b and the glass G may be adsorbed to a lower portion from an upper portion of each of the molding rooms 155a and 155b according to the suction force.

FIG. 6 illustrates a state in which molding of the glass G is completed in the mold unit 150. Towards the seventh curved surface molding part 127 from the first molding part 121, vacuum adsorptive power and temperature may be controlled step by step as increased to a preset value. In addition, when the glass G reaches a softening point, the glass G may be molded with two curved portions with predetermined curvature and one flat portion so as to correspond to upper shapes of each of the molding frames 153a and 153b and each of the molding rooms 155a and 155b according to compressive force due to self load of the upper molds 151 and 153. In this case, vacuum adsorption, heating, and compressive force may be simultaneously applied.

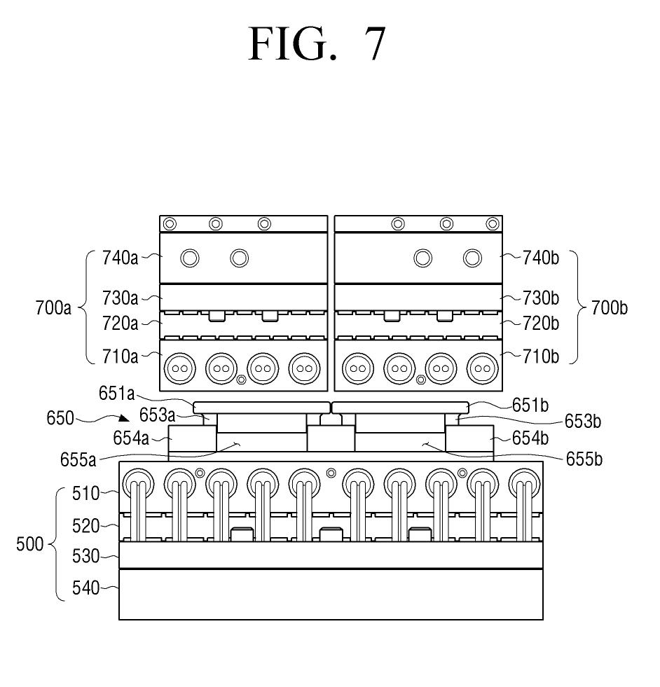

FIGS. 7 to 9 illustrate a mold unit and an upper heater unit according to a first modified example of an exemplary embodiment of the present invention.

Referring to FIG. 7, the mold unit and the upper heat unit according to the first modified example of an exemplary embodiment of the present invention are almost the same as the examples of the mold unit and the second temperature control block according to an exemplary embodiment of the present invention and are different from the examples of the mold unit and the second temperature control block according to an exemplary embodiment of the present invention in that an upper mold of a mold unit and an upper heater unit are separately formed. The mold unit and the upper heat unit according to the first modified example of an exemplary embodiment of the present invention are denoted by the same reference numerals as the mold unit and the second temperature control block according to an exemplary embodiment of the present invention. The first modified example will be described in terms of a difference from the example.

Referring to FIG. 7, a mold unit 650 is used for thermal molding and may include upper molds 651a, 651b, 653a, and 653b and lower molds 654a, 654b, 655a, and 655b which are formed of a metallic material.

Components of the lower molds 654a, 654b, 655a, and 655b of the mold unit 650 according to the first embodied example of an exemplary embodiment of the present invention are the same as components of the lower molds 154 and 155 that are integrally formed according to an exemplary embodiment of the present invention.

However, differently from the upper molds 151 and 153 of the mold unit 150 according to an exemplary embodiment of the present invention, the upper molds 651a, 651b, 653a, and 653b of the mold unit 650 according to the first modified example of an exemplary embodiment of the present invention may be configured in such a way that the upper molds 651a, 651b, 653a, and 653b may be separately formed at each cavity of the lower molds 654a, 654b, 655a, and 655b, that is, each of the molding rooms 655a and 655b.

In more detail, one of the upper molds 651a, 651b, 653a, and 653b may be formed above of each of the molding rooms 655a and 655b. That is, first upper molds 651a and 653a may be formed on first lower molds 654a and 655a, second upper molds 651b and 653b may be formed on second lower molds 654b and 655b, and the first upper molds 651a and 653a and the second upper molds 651b and 653b may be spaced apart from each other by a predetermined interval.

Components of upper heater units 700a and 700b according to the first modified example of an exemplary embodiment of the present invention are almost the same as those of the second temperature control block 300 according to an exemplary embodiment of the present invention but are different from the second temperature control block 300 according to an exemplary embodiment of the present invention in that the upper heater units 700a and 700b are formed as the first upper heater unit 700a and the second upper heater unit 700b that are separately formed.

The first upper heater unit 700a may include a heating block 710a, a heat sink 720a, a plate 730a, and a cooling block 740a and the second temperature control block 300 may be configured in the same way as the heating block 310, the heat sink 320, the plate 330, and the cooling block 340.

The second upper heater unit 700b may also include a heating block 710b, a heat sink 720b, a plate 730b, and a cooling block 740b and the second temperature control block 300 may be configured in the same way as the heating block 310, the heat sink 320, the plate 330, and the cooling block 340.

Differently from the second temperature control block 300 that is configured with one component, the upper heater units 700a and 700b may be configured with a plurality of components to correspond to the upper molds 651a, 651b, 653a, and 653b, respectively. In more detail, the first upper heater unit 700a may be disposed on the first upper molds 651a and 653a and the second upper heater unit 700b may be disposed on the second upper molds 651b and 653b. In addition, the first upper heater unit 700a and the second upper heater unit 700b may be formed to be spaced apart from each other by a preset interval.

The upper molds 651a, 651b, 653a, and 653b and the upper heater units 700a and 700b according to the first modified example of an exemplary embodiment of the present invention with the above configuration may enhance productivity compared with a single cavity by applying a multiple cavity to a mold. In addition, the upper heater units 700a and 700b may be separately applied to each of the upper molds 651a, 651b, 653a, and 653b and, thus, each upper heater unit may be independently controlled to reduce molding quality deviation for each cavity, that is, each molding room of a lower mold, thereby enhancing molding quality of glass, compared with the case in which an upper mold and an upper heater unit are integrally molded.

That is, when the upper mold and the upper heater unit are integrally formed, more heat is applied to a middle portion of a mold unit due to a structure of a heater unit, compared with a lateral portion of the mold unit. According to this configuration, temperature of a middle portion of the upper mold is highest and is lowered toward a lateral end and, thus, quality distribution may occur on glass formed in each mold unit. However, the upper mold and the upper heater unit according to the first modified example of the present invention may be configured in such a way that each separate upper heater unit is installed for each upper mold so as to reduce quality distribution formed in each mold unit.

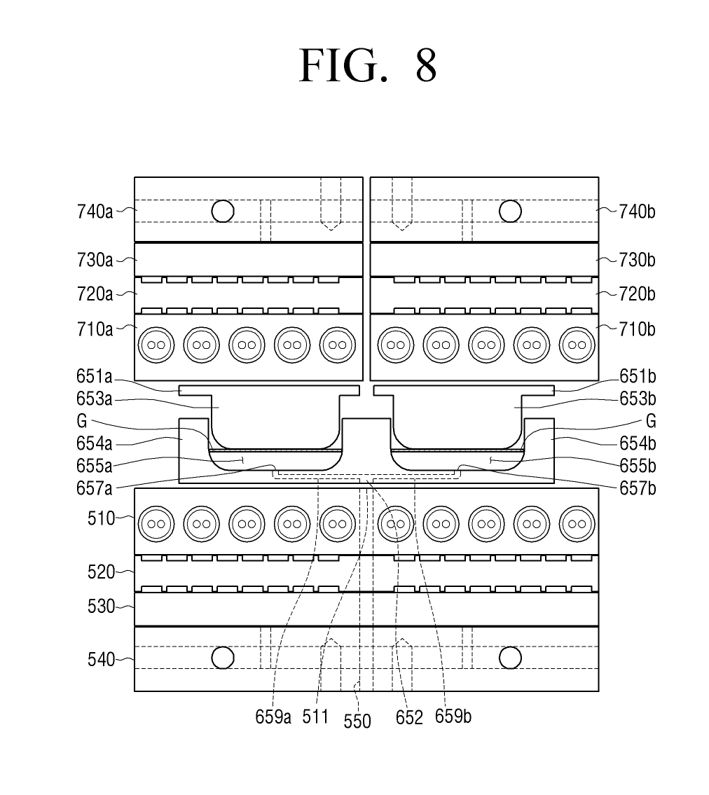

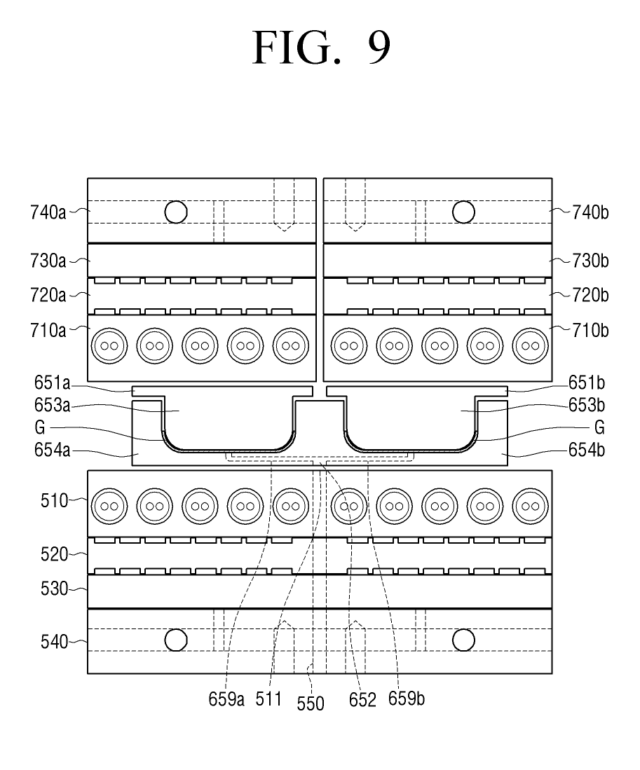

FIG. 8 is a cross-sectional view of a mold unit that enters a molding operation according to a first modified example of exemplary embodiment of the present invention. FIG. 9 is a cross-sectional view of a mold unit on which molding of glass is completed according to the first modified example of exemplary embodiment of the present invention.

Components of the mold unit and the upper heater unit indicating a molding operation according to the first modified example of an exemplary embodiment of the present invention are almost the same as those of the mold unit and the second temperature control block indicating a molding operation according to an exemplary embodiment of the present invention. Accordingly, a detailed description of the same component and operation will be omitted. The mold unit and the upper heat unit according to the first modified example of an exemplary embodiment of the present invention are denoted by the same reference numerals as the mold unit and the second temperature control block according to an exemplary embodiment of the present invention.

FIG. 8 illustrates a procedure of heating the mold unit 650 in a portion of a preheating operation or a molding operation. The glass G may be put in each of the molding rooms 655a and 655b of the plurality of mold units 650. The upper molds 651a, 651b, 653a, and 653b may be put on the glass G.

In the preheating operation, vacuum suction through a suction passage 550 may not be applied to the mold unit 650. However, as the mold unit 650 enters a molding operation, suction force of a vacuum suction device (not shown) through a suction passage 550 may be applied to a lower portion of the mold unit 650.

According to suction force of a vacuum suction device (not shown) through the suction passage 550, the glass G may be adsorbed on each of the molding rooms 655a and 655b.

FIG. 9 illustrates a state in which molding of the glass G is completed in the mold unit 650. During a molding operation, vacuum adsorption, heating, and compressive force may be simultaneously applied to the glass G.

When the upper molds 651a, 651b, 653a, and 653b are integrally formed, mold covers 651a and 651b may be connected and bending deflection may occur due to self load of each of molding frames 653a and 653b at the connection portions. Accordingly, predetermined load may not applied to each glass G. The upper molds 651a, 651b, 653a, and 653b according to an exemplary embodiment of the present invention and the upper heater units 700a and 700b according to the first modified example are configured in such a way that loads of the upper molds 651a, 651b, 653a, and 653b is constantly applied to the glass G in each of the molding rooms 655a and 655b as the upper molds 651a, 651b, 653a, and 653b are separately formed. Accordingly, molding quality deviation for each cavity may be advantageously reduced.

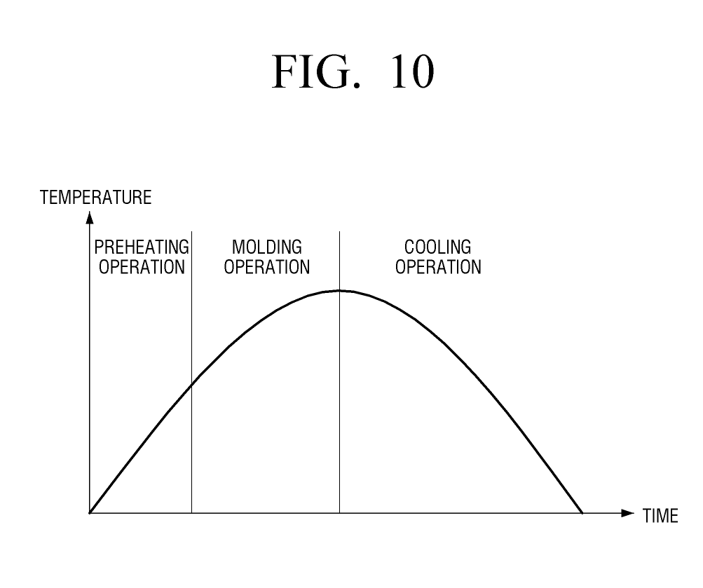

FIG. 10 is a schematic diagram illustrating change in temperature while the mold unit 150 passes through the preheating part 110, the curved surface molding part 120, and the cooling part 140.

During a preheating operation at room temperature, temperature begins to increase. During a molding operation, temperature may further increase to show highest temperature distribution in the seventh curved surface molding part 127. As described above, a shape of the heat sink 220 may be differently configured. Accordingly, temperature gradient of the curved surface molding part 120 may be smoothly controlled to a preset value using temperature of the seventh curved surface molding part 127 as a peak. That is, the molding part 130 may gradually reduce a rate of increase of heat applied to the plurality of mold units 150 toward the cooling part 140 from the inlet part I₁.

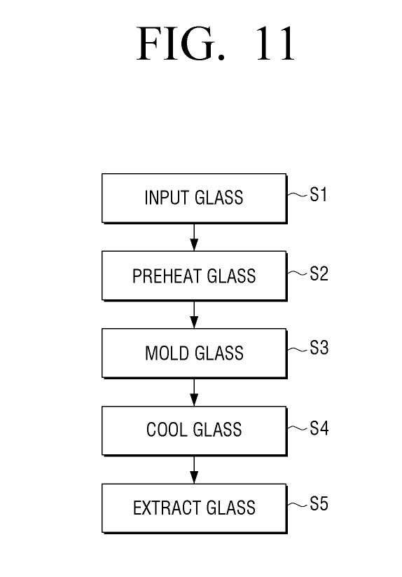

Hereinafter, a mobile window method for molding curved glass according to the present invention will be described in detail with reference to FIG. 11.

As illustrated in FIG. 11, the mobile window method for molding curved glass according to an exemplary embodiment of the present invention will be described below.

First, the glass G may be put in the mold unit 150 and the mold unit 150 is input to a first process (S1).

Then, the glass G may be preheated in the preheating part 110 (S2). Vacuum adsorptive power may not be applied to the mold unit 150 in the preheating part 110.

The glass G may be molded in the curved surface molding part 120 (S3).

In a heating operation including the preheating operation and the molding operation, rate of increase of heat applied to the plurality of mold units 150 may be gradually reduced toward an end point of the heating operation from a start point of the heating operation.

In the heating operation, the glass G may be molded through vacuum adsorption from the lower molds 154 and 155 of the mold unit 150 and self load compression from the upper molds 151 and 153 of the mold unit 150.

The molded glass G may be cooled in the cooling part 140 (S4).

The glass G on which cooling is completed may be extracted from the mold unit 150 (S5).

In this case, the mold unit 150 may be moved along a closed loop including a first process including S1 to S5 and a second process including the same processes as the first process. In addition, an operator is positioned at the inlet parts I₁ and I₂ and outlet parts O₁ and O₂ between the first process and the second process. The glass G in which molding and cooling are completed may be extracted from the outlet parts O₁ and O₂ and the mold unit 150 from which the glass G is extracted may be cleaned. The glass G may be put in the cleaned mold unit 150 at the inlet parts I₁ and I₂ and the mold unit 150 may be input to the first process and the second process.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

### INDUSTRIAL APPLICABILITY

The present invention relates to an apparatus for molding curved glass and a method for molding curved glass using the same.

1. An apparatus for molding curved glass comprising:
a plurality of mold units formed as one or more cavities in a chamber for thermal molding and comprising a lower mold in which glass is put into each cavity and an upper mold corresponding to a shape of a glass to be processed and disposed on the lower mold; and
first and second processing apparatuses each comprising an inlet part into which the plurality of mold units are put, a preheating part configured to heat the glass, a molding part configured to mold the glass, a cooling part configured to cool the glass molded in the molding part, and an outlet part from which the glass cooled by the cooling part is discharged,
wherein the molding part gradually reduces a rate of increase of heat applied to the plurality of mold units toward the cooling part from the inlet part.

2. The apparatus for molding curved glass as claimed in claim 1, wherein the molding part comprises:
first fixing unit spaced apart below the plurality of mold units; and
second fixing unit spaced apart above the plurality of mold units.

3. The apparatus for molding curved glass as claimed in claim 2, wherein:
the first and second fixing units each comprises a plurality of temperature control blocks; and
the temperature control block comprises:
at least one heating block configured to heat the plurality of mold units;
at least one heat sink stacked on the heating block to contact the heating block; and
at least one cooling block stacked on a plate and formed to lower temperature of the first and second fixing units.

4. The apparatus for molding curved glass as claimed in claim 3, wherein a contact area of the plurality of heat sinks with the heating block is gradually increased toward the cooling part from the inlet part.

5. The apparatus for molding curved glass as claimed in claim 4, wherein the cooling block and the heating block exchange heat and a rate of increase of temperature of the plurality of mold units in the chamber is gradually reduced toward the cooling part from the inlet part as the contact area of the plurality of heat sinks with the heating block is gradually increased.

6. The apparatus for molding curved glass as claimed in claim 4, wherein a straight line type protrusion is periodically and repeatedly formed on upper portion and lower portion of each heat sink.

7. The apparatus for molding curved glass as claimed in claim 3, wherein a suction passage connected to a vacuum suction device is formed in the first fixing unit and the suction passage extends to a suction hole formed on an upper portion of the heating block of the first fixing unit.

8. The apparatus for molding curved glass as claimed in claim 7, wherein:
the lower mold comprises a suction flow path formed on a lower portion of the lower mold; and
the plurality of mold units performs vacuum adsorption on a lower portion of the glass for a predetermined time at a location corresponding to the suction flow path and the suction hole and, simultaneously, compresses an upper portion of the glass by self load of the upper mold and an upper heat unit.

9. The apparatus for molding curved glass as claimed in claim 1, wherein the first and second processing apparatuses are arranged in parallel.

10. The apparatus for molding curved glass as claimed in claim 1, wherein inert gas is injected into the chamber to prevent the mold unit from being oxidized.

11. The apparatus for molding curved glass as claimed in claim 10, wherein opening and closing doors are formed at opposite ends of the molding part in order to prevent the inert gas from leaking when the plurality of mold units are input or discharged.

12. The apparatus for molding curved glass as claimed in claim 3, wherein each of the temperature control blocks further comprises at least one plate disposed between the heat sink and the cooling block.

13. The apparatus for molding curved glass as claimed in claim 1, wherein the first and second processing apparatuses are arranged to form a closed loop and constitute a 2 column rotation structure.

14. A method for molding curved glass comprising:
putting glass into a plurality of mold units;
preheating the glass;
molding the heated glass;
cooling the molded glass; and
sequentially extracting the completely cooled glass from each of the mold units,
wherein a rate of increase of heat applied to the plurality of mold units is gradually reduced toward the cooling from the preheating.

15. The method for molding curved glass as claimed in claim 14, wherein the molding comprises molding the glass via vacuum adsorption of a lower mold of the mold units, self load compression of an upper mold of the mold unit, and an upper heater unit.
